(19) United States
(12) Patent Application Publication
(10) Pub. No.: US 2006/0152510 A1
(43) Pub. Date: Jul. 13, 2006

(54) Cross-platform and data-specific visualisation of 3d data records

(76) Inventors: Jochen Dick, Uttenreuth (DE); Joachim Hornegger, Monrendorf (DE)

Correspondence Address: SCHIFF HARDIN, LLP;PATENT DEPARTMENT, 6600 SEARS TOWER, CHICAGO, IL, 60606-6473, US

(21) Appl. No.: 10/518,143

(22) PCT Filed: Jun. 6, 2003
(86) PCT No.: PCT/DE03/01898

§ 371 Date: Aug. 2, 2005

(51) Int. Cl. G06T 11/20

(52) U.S. Cl. 345/440

(57) ABSTRACT

In a device for cross-platform and data-specific visualization of 3D data records using visualization software for display on a 2D monitor, the 3D volume data are stored together with visualization software on a data carrier, the data carrier being transmittable to a user for playback on any personal computer.

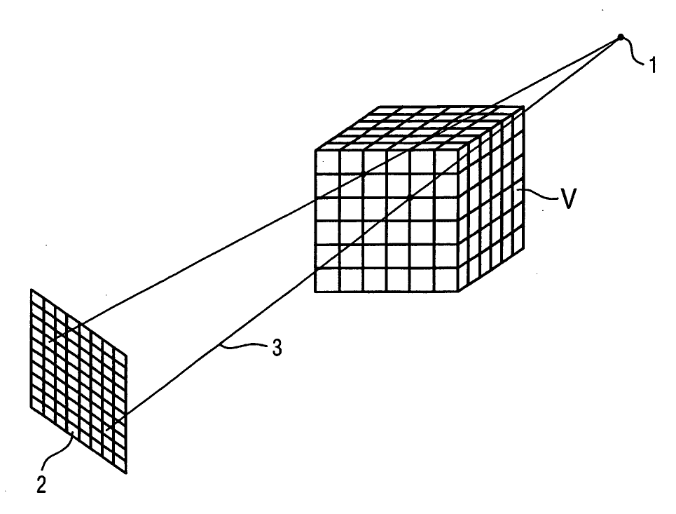

### BACKGROUND OF THE INVENTION

1. Field of the Invention

The invention relates to a device for cross-platform and data-specific visualization of 3D data records by means of visualization software for display on a 2D monitor.

2. Description of the Prior Art

The brochure entitled “SIENET MagicView 300, Image Reporting, Image Processing and All That Goes With It” describes a viewer for visualizing 2D data records, as may be gathered from the first column on page 2. It is stated there that a digital image is defined as a matrix of discrete values that represent the gray-scale values. However, a matrix is always two-dimensional and does not represent a data volume such as is supplied, for example, as a 3D data record from a CT, MR or C-arm CT.

Conversion of 2D acquired datasets to 3D volume data records leads to up the problem of having to exchange the volume data among doctors and of having to visualize them on different computers. In order to ensure uniform image quality, in addition to the medical data record it is necessary to make available a program that permits the visualization of the 3D data on the 2D monitor. The use of different methods for volume visualization together with the many possibilities for parameterizing the algorithms lead to a different image quality.

To date, such volume data generally have been exchanged by transmitting the volume data record via a DICOM interface to a medical workstation at which expensive volume visualization software is installed, although difficulties can occur in turn here as well when this volume visualization software is not the same as that which was used on the original computer of the radiologist.

In addition, individual views of the volume data record have also been generated, stored in a standard image format and passed on. Images can be viewed on any desired PC with the aid of standard programs such as photoshop, for example. Finally, it has also been proposed to store a number of fixed views in a set sequence as a digital video (avi, for example) and then play them back using standard software tools.

### SUMMARY OF THE INVENTION

An object of the present invention is to provide a device for cross-platform, data-specific visualization of 3D data records which, in conjunction with a simple design, operates independently of the computers respectively used and of any possible visualization software, and thereby permits 3D volume data records to be ordered and viewed by any desired third parties with the best play back quality.

This object is achieved in accordance with a device for cross-platform and data-specific visualization of 3D data records wherein the invention provides that the 3D volume data are stored together with visualization software on a data carrier, and the latter is transmitted to a user for playback on any desired PC.

Storing the 3D volume data record together with any (desired) visualization software means that 3D volume can be visualized on any PC without software additionally installed on said PC. Moreover, the unit of data record and visualization algorithm ensures that no general visualization tool with the aid of which any desired data records can be displayed is involved.

In an embodiment of the invention the visualization parameters are also stored on the data carrier in an at least partially unchangeable fashion. This yields the advantageous possibility of, for example, making a 3D volume data record, produced by a radiologist and in which specific structures have been specially emphasized by specific visualization parameters, available to the operator in the operation room, in which case the latter then also sees precisely the structures that the radiologist has emphasized via the visualization parameters on the basis of his specialist knowledge. In many cases, it can be expedient, when transmitting such 3D data to less experienced doctors, not to leave to the physician all the possibilities of selecting the various visualization parameters, since in most cases they are overwhelmed and, in the final analysis, are unable to extract any useful image at all from the data. Storing the 3D volume with visualization software and the visualization parameters found by the radiologist to be the best possible display of a specific structure on a data carrier, preferably a CD, makes it possible in a simple way to solve the problem of passing on such 3D volume data records among doctors by making passing them on very simple, so that the receiver requires no special facilities (expensive visualization software on his or her work station). Moreover, the data of the 3D volume data record that are of interest to the receiver can be passed on such that even a non-radiologist obtains an optimum display. Of course, even in such a case with fixed visualization parameters the operator still has the options of spatially rotating the 3D volume data record, for example with specially emphasized bone structures or else arborizations, and of regarding them from all possible points of view in order to prepare for a surgical operation.

### DESCRIPTION OF THE DRAWINGS

The single FIGURE schematically illustrates the projection of a 3D volume data record onto a 2D monitor.

### DESCRIPTION OF THE PREFERRED EMBODIMENTS

When a 3D volume data record is being produced, the volume of interest is transirradiated from an optical center 1, and the points lying on the line of transirradiation are imaged in an image plane. A 3D volume data record can be calculated with the aid of an algorithm from a number of two-dimensional images produced from different optical centers 1. In the reconstruction, shown in the FIGURE, of the 3D data record on a 2D monitor 2, the points lying on a projection ray 3 are added to the 3D volume V in accordance with variable points of view, specifically the so-called visualization parameters, for example with their gray-scale values, and imaged on the 2D monitor 2 as a pixel. The setting of the visualization parameters is a particularly difficult art in this case and is mastered only by experienced radiologists, whereas normal doctors are able only with great difficulty to emphasize the structures they desire from a 3D volume data record. For example, depending on the setting of the visualization parameters, vascular arborizations in the 3D volume V, for example, are specially emphasized, or else specific bone structures or other medical details. If these visualization parameters are recorded in common on a data record together with the visualization software respectively used and the 3D volume data by the recording radiologist, in particular burnt onto a CD, this data record can very easily be sent to a doctor or another department of a hospital where a simple PC requiring no special visualization installations of any sort, that is to say, in particular, on which there is no need to install any expensive visualization software, is sufficient for visualization. The simultaneous co-storage of the visualization parameters as far as possible in a way such that the receiver is no longer capable of changing them has the advantage that even less experienced doctors can view on their simple PC with the best image quality precisely the structures emphasized by the radiologist.

An exemplary scenario is as follows.

A neuroradiologist generates a three-dimensional volume data record using an angiography unit, edits the volume in such a way that an aneurism is effectively displayed, and burns a CD for the neurosurgeon. The neurosurgeon takes the CD, plays it on a standard PC and can visualize and analyze the 3D data record directly. The neurosurgeon is not dependent on a special work station, can inspect the data record on any desired computer, and can do so, moreover, with the same quality as the neuroradiologist.

Although modifications and changes may be suggested by those skilled in the art, it is the invention of the inventors to embody within the patent warranted heron all changes and modifications as reasonably and properly come within the scope of his contribution to the art.

We claim as our invention:

1. A device for cross-platform and data-specific visualization of 3D data records by visualization software for display on a 2D monitor, a processor in which 3D volume data are stored together with visualization software on a data carrier, the data carrier being transmittable to a user for play back on any PC.

2. The device as claimed in claim 1, wherein said processor also stores visualization parameters on the data carrier in an at least partially unchangeable fashion.

3. The device as claimed in claim 2, wherein the data carrier is a CD.
